(19) United States
(12) Patent Application Publication
(10) Pub. No.: US 2007/0083653 A1
(43) Pub. Date: Apr. 12, 2007

(54) System and method for deploying information handling system images through fibre channel

(76) Inventors: Balasubramanian Chandrasekaran, Austin, TX (US); Scott Stanford, Austin, TX (US)

Correspondence Address: HAMILTON & TERRILE, LLP, P.O. BOX 203518, AUSTIN, TX, 78720, US

(21) Appl. No.: 11/228,630

(22) Filed: Sep. 16, 2005

(51) Int. Cl. G06F 15/173

(52) U.S. Cl. 709/225

(57) ABSTRACT

Information handling system images are deployed through a storage area network Fibre channel fabric. The information handling system issues a deployment request through a host bus adapter to a deployment module associated with a storage processor of the storage area network. The deployment module allocates an image stored in a storage device of the storage area network to the information handling system. For instance, an initial deployment image request made upon initial deployment of the information handling system allocates a pre-cloned LUN having a desired operating system so that the information handling system can perform an initial boot with the operating system.

### BACKGROUND OF THE INVENTION

1. Field of the Invention

The present invention relates in general to the field of information handling system image deployment, and more particularly to a system and method for deploying information handling system images through Fibre channel.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often work with and manage large amounts of information. In order to improve organization of and access to information, storage area networks (SANs) are sometimes used. A SAN typically includes plural storage devices interfaced with a Fibre channel network and managed by one or more storage processors. Server information handling systems interface with the SAN through host bus adapters (HBA) and typically have storage assets assigned by SCSI logical unit numbers (LUNs). The server information handling systems interface with client information handling systems, such as over a local area network (LAN), to allow access by the clients to information stored on the SAN. In such network configurations, the server information handling systems are often “headless,” meaning that they do not have local display and I/O peripherals. To reduce cost and improve manageability, headless servers interfaced with a SAN often do not include local hard disk drives for permanent storage of information. Instead of using local storage, headless servers often rely on the SAN for storage of an operating system, applications and configuration information. On start-up, a headless server typically initiates a Boot from SAN (BFS) with its HBA to retrieve and run the operating system and applications in local memory. For instance, during BFS the HBA is configured to retrieve the operating system from a LUN assigned to the headless server.

One difficulty with SANs is that the configuring of server information handling systems to interface with a SAN tends to be a complicated and time- consuming process. Often, on initial start-up the server boots to a Preboot Execution Environment (PXE) by having a network interface card of the server retrieve an operating system from a remote server through an Ethernet network, such as a LAN, followed by retrieval of an image for configuring the server. Although a PXE boot normally provides a convenient way to distribute images to newly deployed server information handling systems, with systems that support BFS and locally installed images, deploying images through PXE via Ethernet has several disadvantages. During such a PXE deployment, the image is typically retrieved by the remote server from the SAN, communicated through the LAN to the newly deployed server to the newly deployed server and then stored by the newly deployed server back to the SAN. This process takes time, consumes LAN bandwidth, typically requires separate deployment networks or complex switch segmentation configurations, and complex configuration files to support multiple NDIS layer network drivers for multi-homed systems with network adapters from different vendors.

### SUMMARY OF THE INVENTION

Therefore a need has arisen for a system and method which deploys information handling system images in a SAN environment.

In accordance with the present invention, a system and method are provided which substantially reduce the disadvantages and problems associated with previous methods and systems for deploying information handling system images. A deployment request is sent through a storage area network Fibre channel fabric from the information handling system to a storage processor of the storage area network. The storage processor allocates an image stored on the storage area network to the information handling system.

More specifically, a deployment module associated with a storage area network storage processor coordinates the allocation of images available on the storage area network to information handling systems that issue image deployment requests, such as a request for initial deployment of an operating system image or a request for deployment of an operating system patch to an existing image. For instance, the deployment module allocates a pre-cloned LUN or ISO (a file format for CDROMS) in response to an initial deployment request and the information handling system retrieves the operating system from the allocated image to support an initial boot. Alternatively, the deployment module clones or creates an image from a template repository and allocates the image to a storage location within the storage area network for access by the information handling system. The deployment module selects an image to allocate based on the deployment policy setting associated with the received deployment request. The deployment request is routed to a predetermined storage processor through the Fibre channel fabric, such as through Fibre channel switches, based on the access control policy setting associated with the received deployment request.

The present invention provides a number of important technical advantages. One example of an important technical advantage is that information handling system images are deployed through the Fibre channel of the SAN instead of through an Ethernet PXE LAN interface. Direct communication of an image over Fibre channel takes less time than communication through Ethernet and reduces the demand on bandwidth of a LAN associated with deployment of a server information handling system to the LAN. Indeed, for deployment of pre-cloned images, such as from templates stored on the SAN, the use of Fibre channel bandwidth is minimal if not avoided. Policy based deployment of operating system images extends to patch management for both physical and virtual machines. Security for deployments is improved within the SAN, and the high bandwidth and long distance capabilities of Fibre channel signaling technologies allows for operating system deployment through Fibre channel based Campus, MAN and WAN networks.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for deploying information handling system images through a storage area network Fibre channel network; and

FIG. 2 depicts a flow diagram of a process for deploying information handling system images through a storage area network Fibre channel network.

### DETAILED DESCRIPTION

Information handling system images are deployed through a storage area network Fibre channel fabric to by requesting deployment from an information handling system through the storage area network. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

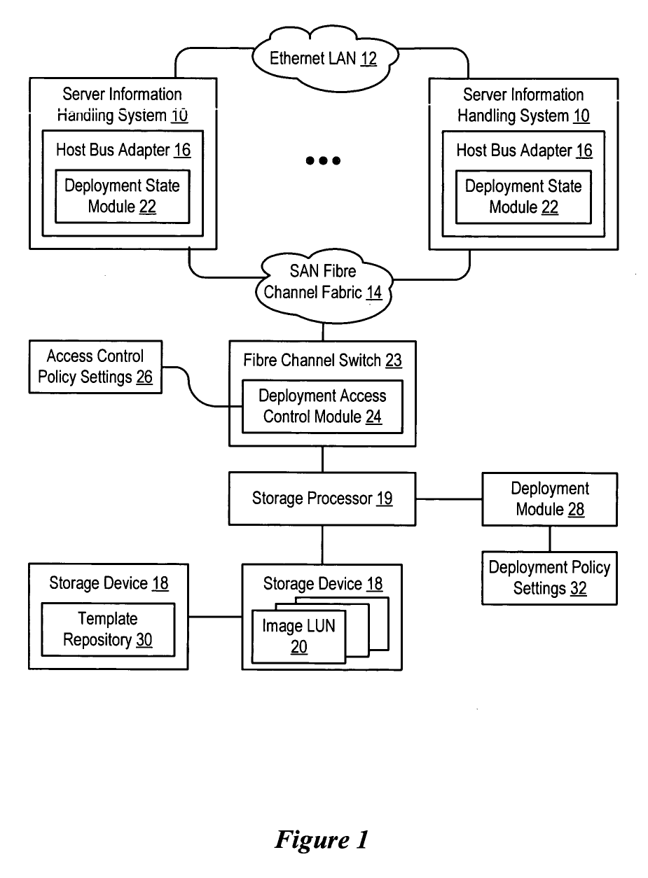

Referring now to FIG. 1, a block diagram depicts a system for deploying information handling system images through a storage area network Fibre channel network. Information handling systems 10 are configured as servers that communicate information through an Ethernet LAN 12 and store information through a SAN Fibre channel fabric 14. Information handling systems 10 are built from various processing components, such as CPUs and RAM, including a host bus adapter 16, which interfaces the system 10 with the SAN Fibre channel fabric 14. Typical configurations of server information handling systems 10 are headless and lack permanent storage, such as a hard disk drive, with the information handling system 10 using the SAN 14 to store and access from a storage device 18 an image LUN 20. For instance, image LUN 20 stores an operating system and applications run by an information handling system 10 that are retrieved and run with BFS upon application of power to the information handling system 10. Communication of information between information handling systems 10 and storage devices 18 is managed by one or more storage processors 19. Information is directed through SAN Fibre channel fabric 14 to desired storage processors 19 and storage devices 18 by Fibre channel switches 23.

Conventional deployment of an image with PXE techniques involves communication of the image through Ethernet LAN 12 to a target information handling system 10 for storage on a storage device 18. To reduce use of LAN bandwidth and more rapidly deploy images, an image deployment request is managed through the SAN Fibre channel fabric 14 instead of LAN 12. A deployment state module 22 stores the current image deployment state of an information handling system 10 and interacts with the SAN Fibre channel fabric 14 to manage the state of the image associated with the information handling system. For instance, deployment state module 22 is integrated in firmware of host bus adapter 16 to communicate the current image state upon initial power-up of its associated information handling system 10. The current image state is routed through Fibre channel fabric 14 by Fibre channel switches 23, including internal storage controller switches, by deployment access control modules 24 that reference access control policy settings 26. For instance, if the deployment state issued from a deployment state module 22 is associated with a request for an initial deployment of an image, then the request is forwarded to a storage processor 19 having a deployment module 28 configured to perform an initial operating system deployment. By comparison, if the deployment state is associated with an outdated version of an operating system, then the deployment request is forwarded to a deployment module 28 configured to provide a patch to update the operating system. After completion of the deployment of a new or update image, deployment module 28 provides new state information to deployment state module 22, which allows information handling system 10 to boot from the image.

Deployment module 28, such as firmware running on an associated storage processor 19, creates access control for newly deployed images, such as a Storage Group, and then allocates a storage location for deployment of the image. As an example, for the deployment of an image in response to issuance of an initial deployment request, deployment module 28 assigns an already existing image, such as a pre-cloned LUN or ISO residing in a storage device 18. As another example, deployment module 28 clones or creates LUNs or ISOs on demand, such as from a template repository of images 30 available in a storage device 18, such as to update an existing image with an operating system patch. The desired action for deployment module 28 is determined by comparison of the deployment state information with deployment policy settings 32. Once the image is deployed, the information handling system 10 associated with the image can access the image, such as in an allocated LUN communicated by deployment module 28 to the appropriate deployment state module 22. Thus, for instance, a deployment request issued from a newly deployed information handling system is answered in relatively little time with the location of an image for the information handling system to use in a BFS boot.

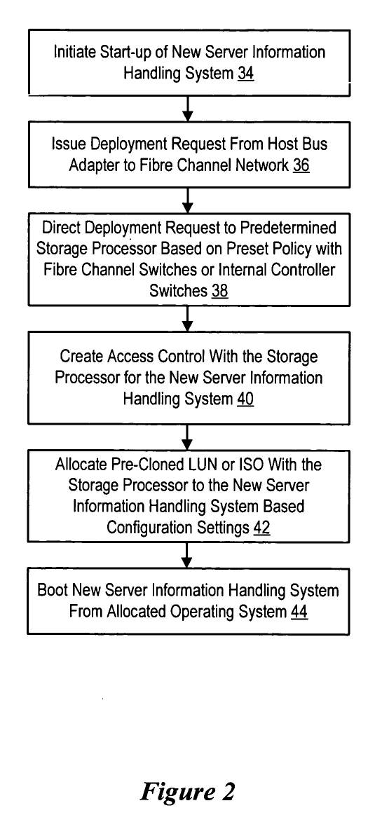

Referring now to FIG. 2, a flow diagram depicts a system, for deploying information handling system images through a storage area network Fibre channel network. The process begins at step 34 with initiation of start-up of a newly-deployed server information handling system interfaced with a SAN. At step 36, the information handling system issues a deployment request from its host bus adapter to the Fibre channel network of the SAN. At step 38, the deployment request is directed to a predetermined storage processor based on preset policies distributed through the Fibre channel fabric, such as Fibre channel switches or internal controllers. At step 40, the storage processor creates access control for the new server information handling system. At step 42, a pre-cloned LUN or ISO is allocated with the storage processor to the new server information handling system based on configuration settings associated with the deployment request. In one embodiment, the image deployed in response to a deployment request may instead be a patch to an existing image rather than a new image deployment. In an alternative embodiment, the image deployed in response to a deployment request may instead be for deploying applications, BIOS or other firmware upgrades, anti-virus upgrades, or other application patches or installations. At step 44, the information handling system boots from the new image, such as with a BFS across the SAN Fibre channel fabric, using an operating system within the image.

Although the present invention has been described in detail, it should be understood that various changes, substitutions and alterations can be made hereto without departing from the spirit and scope of the invention as defined by the appended claims.

What is claimed is:

1. A system for deploying images through a Fibre channel network to one or more information handling systems interfaced with the Fibre channel network, the system comprising:
a deployment state module associated with at least one of the one or more information handling systems and operable to communicate a deployment state associated with the information handling system to the Fibre channel network;
a storage processor interfaced with the Fibre channel network, the storage processor operable to manage information stored on one or more storage devices; and
a deployment module associated with the storage processor, the deployment module operable to receive the deployment state and allocate an image associated with the deployment state to the information handling system, the image allocated in the storage device managed by the storage processor.

2. The system of claim 1 wherein the deployment state comprises an initial deployment of the information handling system, the deployment module allocating a new image to a new LUN in the storage device.

3. The system of claim 2 wherein the information handling system comprises a server physically interfaced with the Fibre channel and interfaced with a local area network.

4. The system of claim 2 wherein the information handling system comprises one or more virtual servers running on a physical server, the physical server interfaced with the Fibre channel network.

5. The system of claim 1 wherein the deployment state comprises an initial deployment of the information handling system, the deployment module allocating a new image or a new ISO in the storage device.

6. The system of claim 1 wherein the deployment state comprises an image version associated with the information handling system, the deployment module allocating an updated image version to an existing image stored on the storage device and associated with the information handling system.

7. The system of claim 1 further comprising a template registry stored on the storage device, the template registry having plural image templates, the image templates configurable for deployment to information handling systems.

8. The system of claim 1 wherein the deployment module is further operable to communicate allocation of the image to the information handling system, the information handling system initiating boot from the image.

9. The system of claim 1 further comprising one or more deployment access control modules deployed in the Fibre channel network and operable to route the deployment state to the deployment module.

10. A method for deploying information handling system images through a storage area network, the method comprising:
issuing a deployment request from an information handling system to the storage area network;
sending the deployment request through the storage area network to a predetermined storage processor;
allocating with the storage processor an image associated with the information handling system, the image stored in the storage area network; and
accessing the image with the information handling system.

11. The method of claim 10 wherein the information handling system comprises a server and the image comprises an operating system.

12. The method of claim 10 wherein the deployment request comprises an update deployment request and the image comprises an operating system patch.

13. The method of claim 10 wherein the deployment request comprises an initial deployment request and the image comprises an operating system, the method further comprising booting the information handling system with the image.

14. The method of claim 10 wherein sending the deployment request further comprises routing the deployment request to the predetermined storage processor through one or more fibre channel switches by reference to policy settings associated with the deployment request.

15. The method of claim 10 wherein allocating with the storage processor further comprises assigning a pre-cloned LUN to the information handling system.

16. The method of claim 10 wherein allocating with the storage processor further comprises:
retrieving an image from a template repository; and
assigning the image to LUN for use by the information handling system.

17. A storage area network comprising:
plural storage devices for storing information;
one or more storage processors operable to manage the plural storage devices;
Fibre channel fabric interfacing the storage devices and storage processor; and
a deployment module associated with the storage processor, the deployment module operable to receive a deployment request from an information handling system interfaced with the Fibre channel fabric and to allocate an image to the information handling system in a storage device.

18. The storage area network of claim 17 wherein the deployment request comprises an initial operating system deployment, the information handling system operable to boot from the image allocated by the deployment module.

19. The storage area network of claim 17 wherein the image comprises a pre-cloned LUN stored on the storage device.

20. The storage area network of claim 17 wherein the deployment request comprises an updated operating system deployment, the information handling system operable to boot from an updated operating system image allocated by the deployment module.
